(19) United States
(12) Patent Application Publication
(10) Pub. No.: US 2017/0307020 A1
(43) Pub. Date: Oct. 26, 2017

(54) Gripping Mechanism for Installer/Remover Tool

(71) Applicants: Michael ANDREWS, Abbotsford (CA); Tiger Tool International Incorporated, Abbotsford (CA)

(72) Inventor: Michael Andrews, Bellingham, WA (US)

(21) Appl. No.: 15/520,170

(22) PCT Filed: Oct. 23, 2015
(86) PCT No.: PCT/US2015/057201

§ 371 Date: Apr. 19, 2017

Related U.S. Application Data
(60) Provisional application No. 62/068,400, filed on Oct. 24, 2014.

(51) Int. Cl. F16C 35/06; B25B 27/06; F16C 19/36; F16C 35/067

(52) U.S. Cl. CPC F16C 35/062; F16C 35/067; B25B 27/064; F16C 19/364

(57) ABSTRACT

Disclosed herein is a gripping mechanism for use with a pulling device for removal of and/or installation of a bearing race, ring, bushing, or other device press-fit into a recess. The apparatus uses a plurality of arms which rotate outward in a plane orthogonal to the axis of insertion/removal of the bearing race.

### RELATED APPLICATIONS

This application (Attorney's Ref. No. P218464us) is a 371 of International PCT Application No. PCT/US2015/057201 filed Oct. 23, 2015, currently pending.

International PCT Application No. PCT/US2015/057201 claims benefit of U.S. Provisional Application Ser. No. 62/068,400 filed Oct. 24, 2014, now expired.

The contents of all related applications cited above are incorporated herein by reference.

### TECHNICAL FIELD

This disclosure relates to the field of tools for the insertion and/or removal of a bearing race, ring, bushing, or other device press-fit into a recess.

### BACKGROUND

A bearing race, ring, bushing, or other mechanical device is often press-fit, heat-fit, or friction-fit or likewise installed into a recess. For ease in description, the term bearing race will be used to describe this category of components including bearing races, rings, bushings, and other equivalent mechanical apparatuses.

In many applications, especially in the automotive industry, the tolerance between the outer surface of the bearing race and the inner surface of the recess is very low. As the press-fit forces required for the installation of such components is very high, significant force must often be used to remove or install such bearing races within the recesses. “Racking” refers to the installation and/or removal the bearing race within the recess at an offset angle, which will tend to bind or jam the bearing race in the recess.

As shown in U.S. Pat. No. 3,336,652, similar gripping mechanisms generally comprise jaws (30) which pivot about axes or pins (26/27) which are aligned orthogonal to the main shaft 11. While this allows the apparatus to fit into a relatively small opening in the center of the bearing race as shown in FIG. 2 of the U.S. Pat. No. 3,336,652 the jaws are generally made to counter substantial tensile forces between the axis of rotation (26/27) and the fingers (37) which actually engage the bearing race. In addition, the pins (26/27) must be made robust enough to withstand repeated use and generally carry the entire force engaged upon the bearing race during removal or installation.

Many such pulling devices are known in the art such as lever pullers, one of which is disclosed in U.S. Pat. No. 1,334,658; pneumatic pullers such as that disclosed in U.S. Pat. No. 5,787,561; slide hammers such as disclosed in U.S. Pat. No. 3,336,652; screw drives such as disclosed in U.S. Pat. No. 4,769,890 and equivalents and combinations thereof. Many similar pulling devices are well-known in the art for attachment to the gripping mechanisms which engage bearing races for the installation or removal from a recess.

The need thus exists for installer/remover tools for press fit or interference fit parts such as bearing races that allows simple insertion and removal of the parts while minimizing the likelihood of damage the parts.

### SUMMARY

Disclosed herein is a gripping mechanism for use with a pulling device for removal of and/or installation of a bearing race, ring, bushing, or other device press-fit into a recess.

The present invention may be embodied as a gripping mechanism comprising a shaft, an index housing, first and second support members, and a pivot member. The shaft defines a shaft axis. The index housing defines a main gear and an indexing portion, where the index housing is supported by the shaft. The second support member defines at least one indexing surface. The at least one arm defines an arm gear and a finger portion. The pivot member is arranged to connect the at least one arm between the first and second support members such that the first and second support members are supported for movement relative to the shaft along the shaft axis, the at least one arm member pivots between first and second arm end positions relative to the first and second support members, and the arm gear of the at least one arm member engages the main gear. The index housing may be arranged in at least one locked position in which the indexing portion engages the at least one indexing surface to inhibit rotation of the index housing about the shaft axis and an unlocked position in which the indexing portion is disengaged from the at least one indexing surface to allow rotation of the index housing about the shaft axis. The main gear engages the arm gear such that with the index housing in the unlocked position, rotation of the index housing about the shaft axis causes the at least one arm to pivot through at least one arm intermediate position between the first and second arm end positions and, with the index housing in the at least one locked position, the at least one arm is held in the at least one intermediate arm position.

The present invention may also be embodied as a method of gripping a part comprising the following steps. A shaft defining a shaft axis is provided. An index housing defining a main gear and an indexing portion is supported on the shaft. A first support member is provided. A second support member defining at least one indexing surface is provided. At least one arm defining an arm gear and a finger portion is provided. A pivot member is arranged to connect the at least one arm between the first and second support members such that the first and second support members are supported for movement relative to the shaft along the shaft axis, the at least one arm member pivots between first and second arm end positions relative to the first and second support members, and the arm gear of the at least one arm member engages the main gear. The index housing is arranged in an unlocked position in which the indexing portion is disengaged from the at least one indexing surface to allow rotation of the index housing about the shaft axis. The index housing is rotated about the shaft axis to cause the at least one arm to pivot through at least one arm intermediate position between the first and second arm end positions. The index housing is arranged in at least one locked position in which the indexing portion engages the at least one indexing surface to inhibit rotation of the index housing about the shaft axis, where the at least one arm gear is held in the at least one intermediate arm position when the index housing is in the at least one locked position.

The present invention may also be embodied as a gripping mechanism comprising a shaft, an index housing, first and second support members, a plurality of arms, and a plurality of pivot members. The shaft defines a shaft axis. The index housing defines a main gear and an indexing portion, where the index housing is supported by the shaft. The second support member defining a plurality of indexing surfaces. The plurality of arms each define an arm gear and a finger portion. Each pivot member is arranged to connect one of the plurality of arms between the first and second support members such that the first and second support members are supported for movement relative to the shaft along the shaft axis, each arm member pivots between first and second arm end positions relative to the first and second support members, and each the arm gear of the plurality of arm members engages the main gear. The index housing may be arranged in a plurality of locked positions in which the indexing portion engages one of the plurality of index surfaces to inhibit rotation of the index housing about the shaft axis and an unlocked position in which the indexing portion is disengaged from the at least one indexing surface to allow rotation of the index housing about the shaft axis. The main gear engages the arm gear such that, with the index housing in the unlocked position, rotation of the index housing about the shaft axis causes the plurality of arms to pivot through a plurality of arm intermediate positions between the first and second arm end positions and, with the index housing in one of the plurality of locked positions, the at least one arm is held in one of the plurality of intermediate arm positions.

### BRIEF DESCRIPTION OF THE DRAWINGS

FIG. 1 is a top isometric view of one example of the apparatus in an extend orientation and attached to a pulling device;

FIG. 2 is a side cutaway view taken along like 2-2 of FIG. 1 showing the gripping device in the retracted orientation during the process of removing a bearing race from a support housing;

FIG. 3 is a top cutaway view of the apparatus taken along line 3-3 of FIG. 2;

FIG. 4 is a top cutaway view of the apparatus as shown in FIG. 3 with the arms in a partially extended orientation;

FIG. 5 is a top cutaway view similar to that of the apparatus as shown in FIG. 4 with the arms in fully extended orientation;

FIG. 6 is a side cutaway view of the apparatus shown in FIG. 1 in the extended orientation during the process of removing a bearing race from a support housing;

FIG. 7 is a side cutaway view of the apparatus shown in FIG. 1 in the extended orientation during the process of removing a bearing race from a support housing;

FIG. 8 is a detailed cutaway view of the gripping mechanism portion of the apparatus shown in FIG. 1;

FIG. 9 is a detailed cutaway view of the gripping mechanism portion of the apparatus shown in FIG. 1 with the index housing portion lowered to allow rotation relative to the lower disk portion of the gripping mechanism;

FIG. 10 is a bottom isometric view of the gripping mechanism portion of the apparatus shown in FIG. 1 with the index housing portion shown in a lowered position to view the index pin, main shaft gear;

FIG. 11 is a partial cutaway bottom view of the gripping mechanism portion of the apparatus shown in FIG. 1 with the index housing portion removed to show the index pin and main shaft gear;

FIG. 12 is a partial cutaway bottom view of the gripping mechanism portion of the apparatus shown in FIG. 1 with the index housing portion removed to show the effects of movement of the index pin between adjacent index pin receivers;

FIG. 13 is a top isometric view of the gripping mechanism portion of the apparatus shown in FIG. 1 with a variant to some of the arm surfaces;

FIG. 14 is a side cutaway view of the apparatus shown in FIG. 13 in the extended orientation during the process of installing a bearing race into a support housing; and

FIG. 15 is a side cutaway view of the apparatus shown in FIG. 13 in the extended orientation during the final step of installing a bearing race into a support housing.

### DETAILED DESCRIPTION

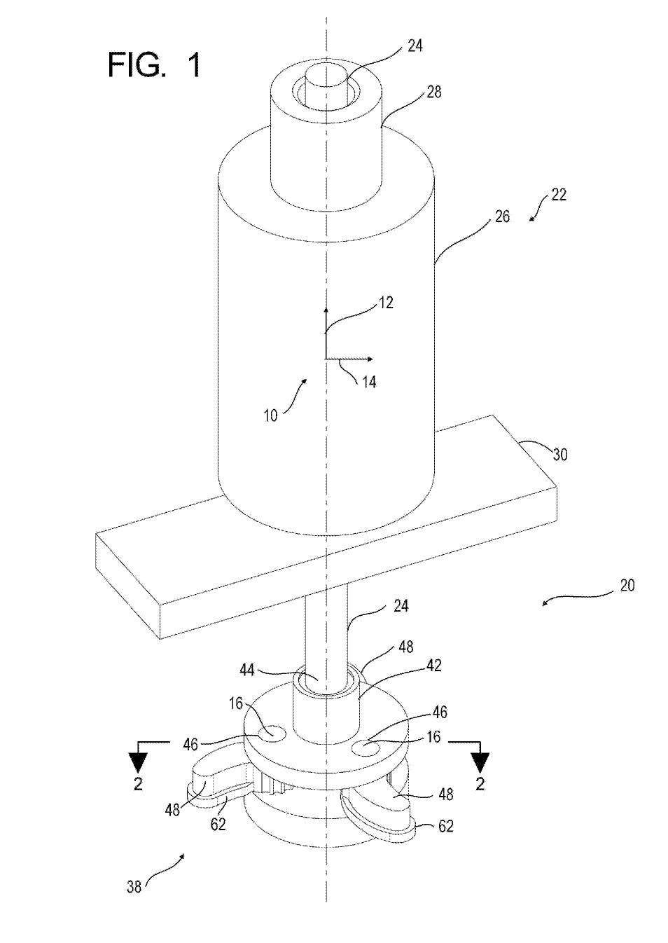

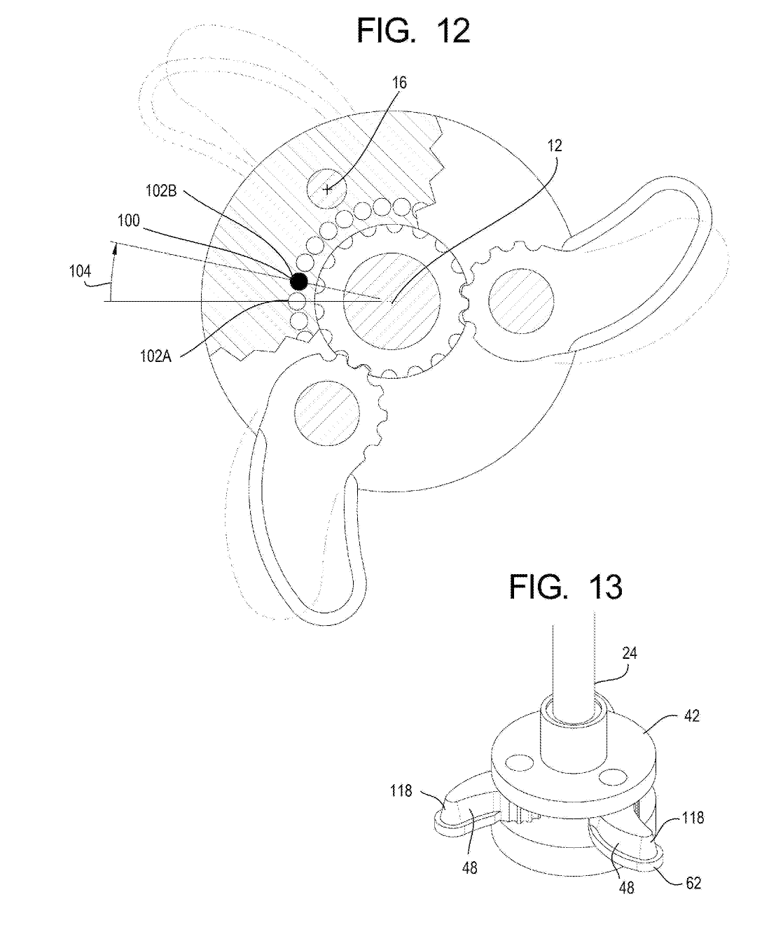

To aid in description, an axes system 10 is disclosed herein. In FIG. 1 for example, a longitudinal axis 12 is shown centered upon the center of the main shaft and parallel to the long axis thereof. A radial axis 14 is shown extending orthogonal to the longitudinal axis 12 in a plane perpendicular to the longitudinal axis 12. In FIG. 12, and arm rotation axis 16 is shown substantially parallel to the long axis 12 and centered upon (tangential to) the pivot of each of the arms.

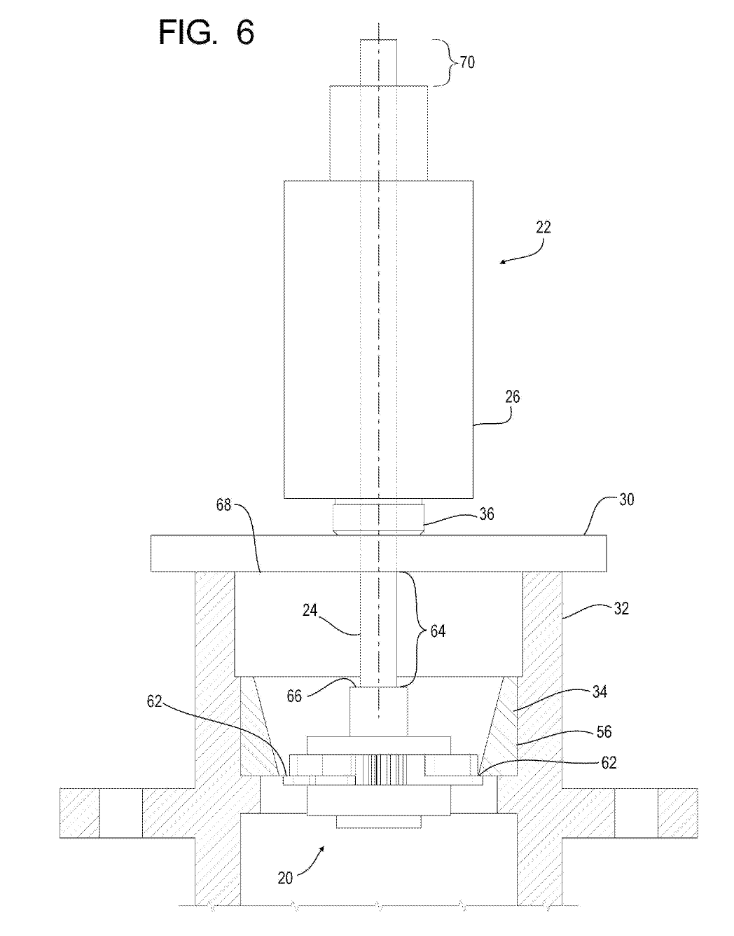

Looking to FIG. 1, the gripping mechanism 20 is shown attached to a pulling device 22 by way of a main shaft 24. The main shaft 24 is shown protruding from the upper end of the apparatus such as can also be seen in the gap between the gripping mechanism 20 and the pulling device 22. In this example, the pulling device 22 comprises an upper housing 26 and a cap 28 engaged around the main shaft 24. The pulling device 22 in this example also comprises a support bar 30 which rests upon the support housing 32 during installation or removal of a bearing race 34 as can be seen in FIG. 6. In at least one example, a thrust bearing/buffer 36 or equivalent apparatus may be positioned between the upper housing 26 and the support bar 30. As previously described, the pulling device 22 is shown schematically so as to represent one or more of the pulling devices disclosed above.

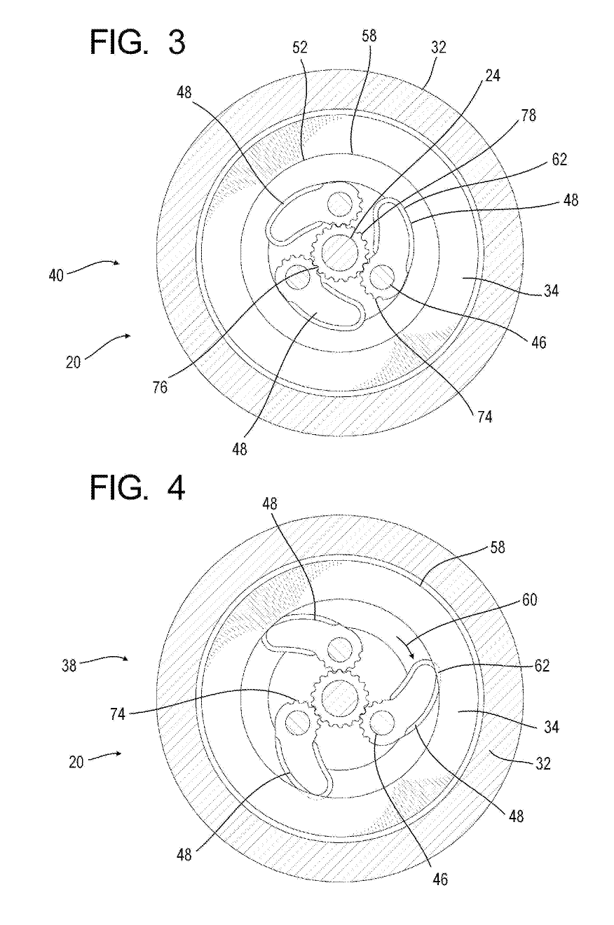

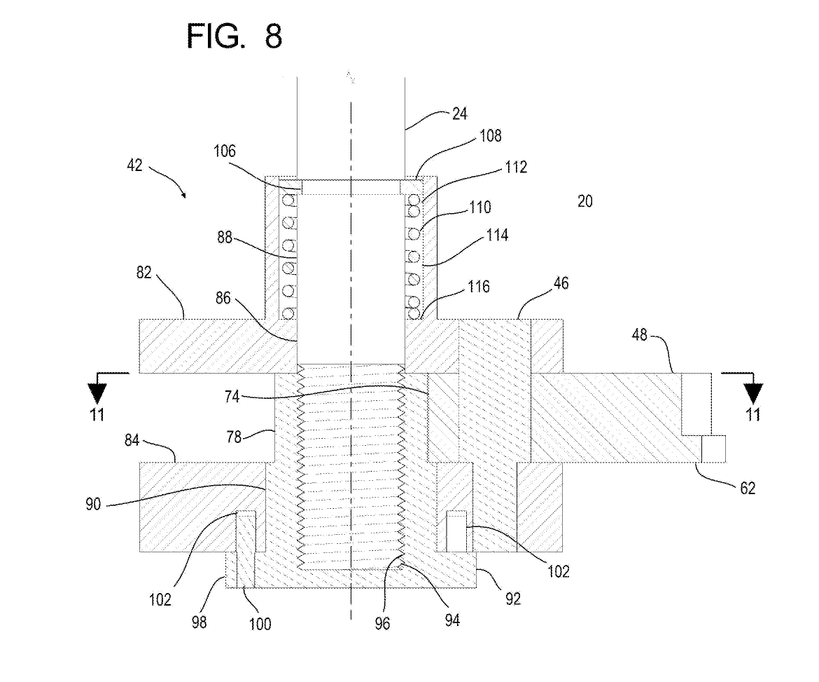

Returning to FIG. 1, the gripping mechanism 20 is shown in an extended orientation 38 which is also demonstrated in FIG. 4. FIG. 3 shows the gripping mechanism 20 in a retracted orientation where the arms are substantially smaller in overall (outer effective) radius. Returning yet again to FIG. 1, the gripping mechanism as shown generally comprises a lower housing 42 attached to a lower longitudinal end 44 of the main shaft 24. Also shown in this drawing are the top ends of a plurality of pivot shafts 46 of which there are three in this example. However; it is conceived that the apparatus would operate as intended with 1, 2, 4 or more pivot shafts 46. Each of the pivot shafts 46 forming an arm rotation axis 16 about which each of the associated arms 48 rotate. In addition, each of the pivot shafts 46 is shown having an arm 48 attached thereto so as to pivot the arm 48 about the associated arm rotation axis 16. These arms 48 together therefore expand radially in a plane orthogonal to the longitudinal axis 12 of the main shaft 24 and also orthogonal to the arm rotation axes 16. In this way, they are very strongly supported by the upper disk 82 and lower disk 84 as can be seen in the cutaway view of FIG. 8.

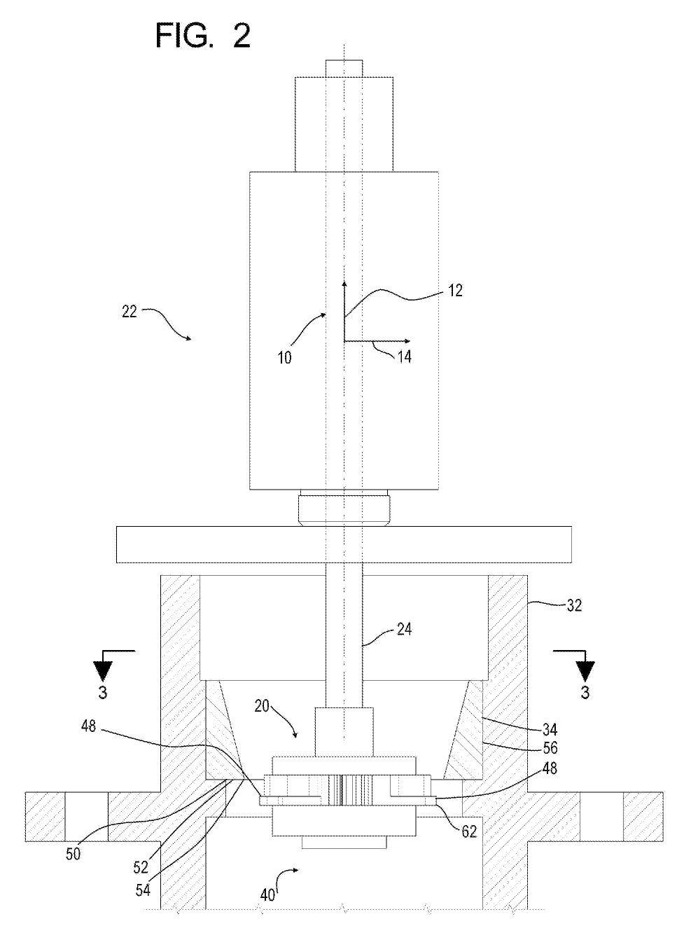

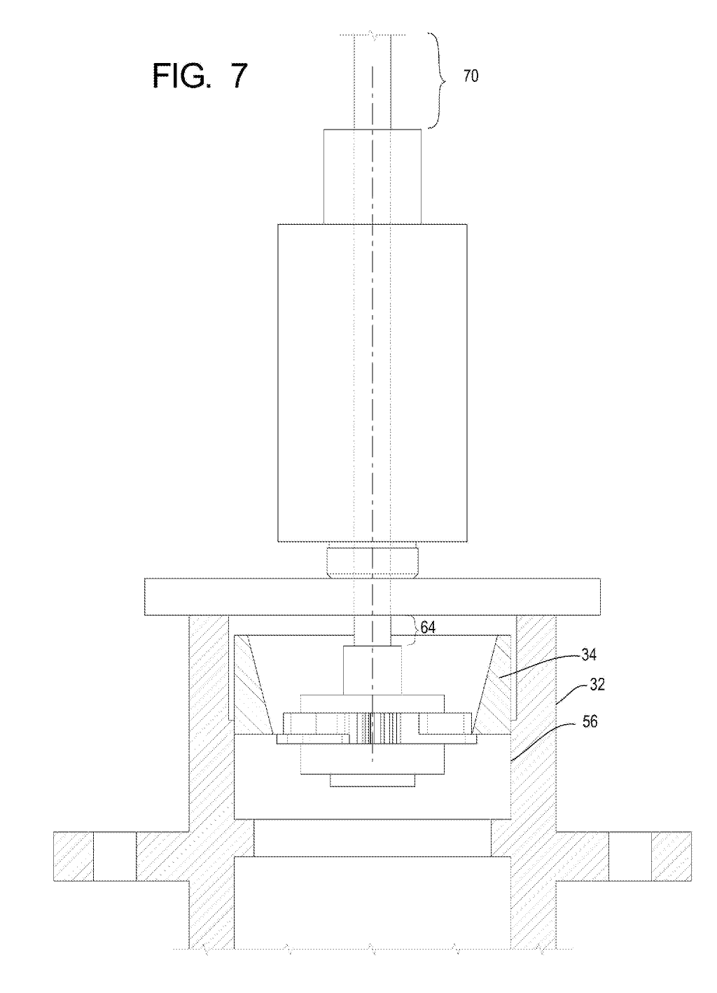

Now to FIG. 2, a pulling device 22 is shown being inserted into the support housing 32 in which a bearing race 34 has been installed. As such, the gripping mechanism 20 is inserted longitudinally past the lower edge 50 of a protrusion 52 of the bearing race 34. In this example, the protrusion 52 has a radially inward edge 54 which is engaged by the arms 48 for removal from the recess 56. As the arms 48 are in the retracted orientation 40 the gripping mechanism 20 will pass longitudinally by the protrusion 52. Looking to FIG. 3, it can be seen that the protrusion 52 of the bearing race 34 has a radially inner edge 58, this edge 58 is generally engaged by the arms 48 during operation. The arms 48 in this retracted orientation 40 will easily pass longitudinally beyond this radially inner edge 58 of the bearing race. Looking to FIG. 4, the arms 48 have been pivoted radially outward in direction of rotation 60 such that the fingers 62 engage the bearing race 34 longitudinally below the radially inner edge 58 as indicated by the dashed line portion of each finger 62. Looking now to FIG. 6, it is clearly shown that by reducing the gap 64 between the upper edge 66 of the gripping mechanism 20 and a lower edge 68 of the support bar 30 and upon actuation of the pulling device 22, tensile forces will be formed in this region of the main shaft 24, biasing the bearing race 34 out of the recess 56. When sufficient tensile force is provided in this region of the shaft 24, the bearing race 34 will be withdrawn as shown in FIG. 7 wherein the gap 64 is substantially smaller than as shown in FIG. 6. This is also shown in the upper longitudinal and where the extension portion 70 of the main shaft 24 above the pulling device 22 is shown substantially shorter in FIG. 6 than in FIG. 7.

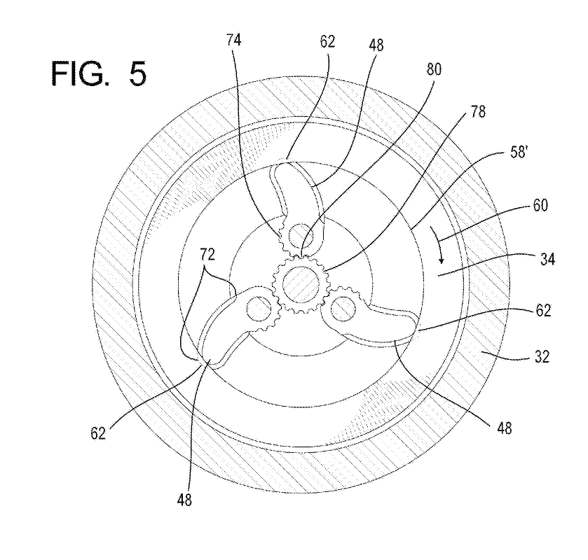

In FIG. 5, a slightly different bearing race is shown wherein the inner edge 58′ has a substantially larger inner diameter than that shown in FIG. 4. As such, each of the arms 48 are rotated substantially further in direction of rotation 60 than that shown in FIG. 4 when they contact the inner edge. In the example shown, each of the arms 48 include a finger 62 defined by a finger region 72 which extends radially outward along the perimeter edge of each arm 48 so as to contact the bearing race 34 has shown in FIG. 4 or 5. This design allows contact with the bearing race 34 at several other locations along the finger region 72.

Looking to FIG. 3, it can be seen how in this example, the ends of each arm 48 opposite the fingers 62 relative to the associated pivot shaft 46 include a gear comprising surfaces defining detents and indents (teeth and grooves) forming an arm gear 74. Looking to the example shown in FIG. 3, each of the arms 48 is shown rotated to a substantially fully retracted orientation 40 wherein the last tooth 76 of the arm gear 74 has engaged the main shaft gear 78. Thus, continued inward rotation of each arm 48 is substantially prohibited. Looking to FIG. 4, the arms 48 are in a partially extended orientation 38 wherein the arms 48 are free to rotate inward or outward relative to each of the pivot shafts 46. In FIG. 5, the first tooth 80 of each arm gear 74 has engaged the main shaft gear 78 and therefore continued rotation in direction 60 is substantially prohibited. As continued rotation in direction 60 generally tends to retract each of the arm gears inward, such rotation may serve little purpose.

Looking to FIG. 8, it can be seen in this cutaway view that in this example the main shaft 24 passes through the gripping mechanism 20 in particular, the main shaft is shown in close fit to the radial inner surface of the lower housing 42. As the upper disk 82 portion of the lower housing 42 has a radially inner surface 86 which is substantially the same diameter, or slightly larger diameter as the outer diameter surface 88, the main shaft 24 is substantially free to pass through the upper disk 82 save for a ring. Likewise, the lower disk 84 has a radially inner surface 90 which in this example is substantially larger than the outer surface 88 of the main shaft 24 and would likewise allow passage of the main shaft 24 were it not for the index housing 92 attached thereto. In the example shown, the lower longitudinal end of the main shaft 24 comprises male threads 94 which are threaded into female threads 96 of the index housing 92 and therefore fasten the main shaft 24 to the index housing 92. It is to be understood that other fastening systems could be utilized such as welding, heat fit, press-fit etc.

As shown, the index housing 92 comprises a radially outer flange 98 which prohibits passage of the index housing 92 through the surface 90. In addition, the flange 98 in this example has an index pin 100 fixed thereto so as to selectively engage an index pin receiver 102. Thus, as the index housing 92 is rotated relative to the lower disk 84, the index pin 100 may align with an index pin receiver 102 whereupon insertion of the index pin 100 prohibits rotation of the index housing 92 relative to the lower disk 84.

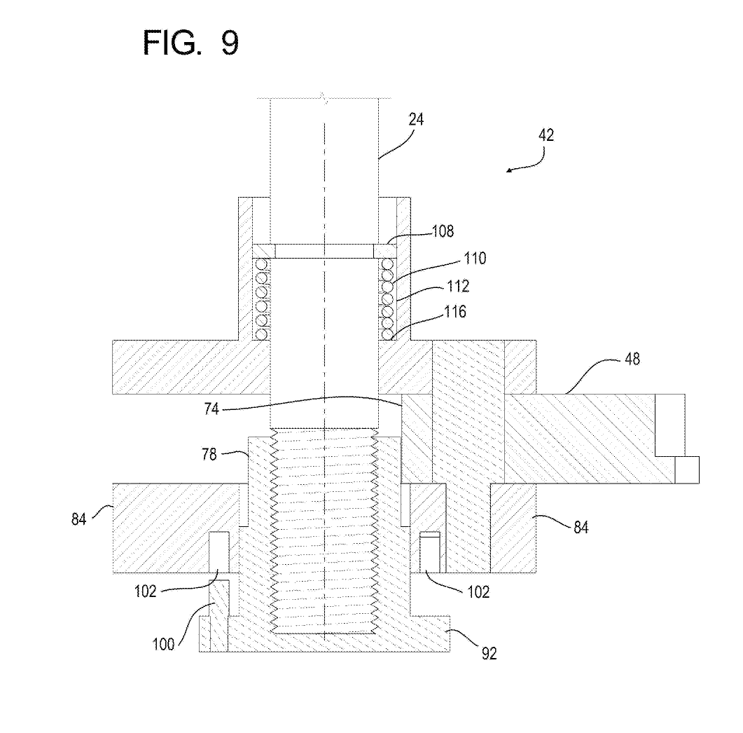

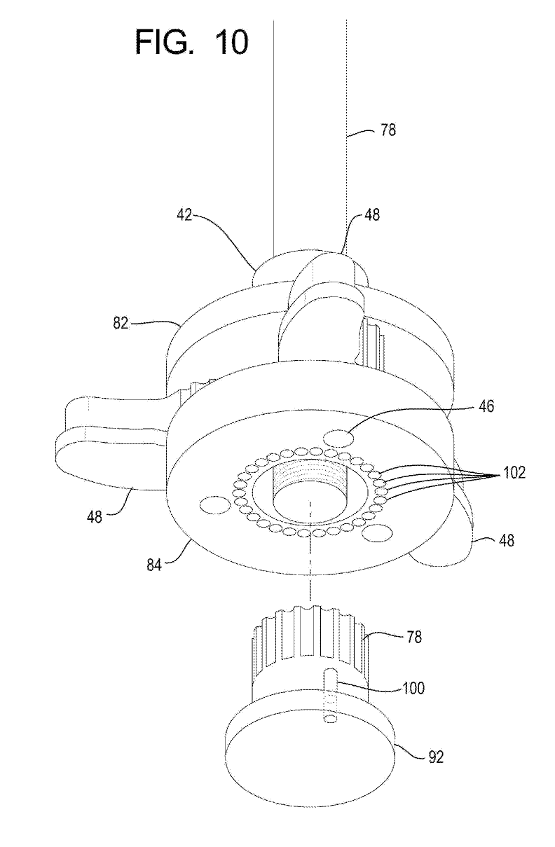

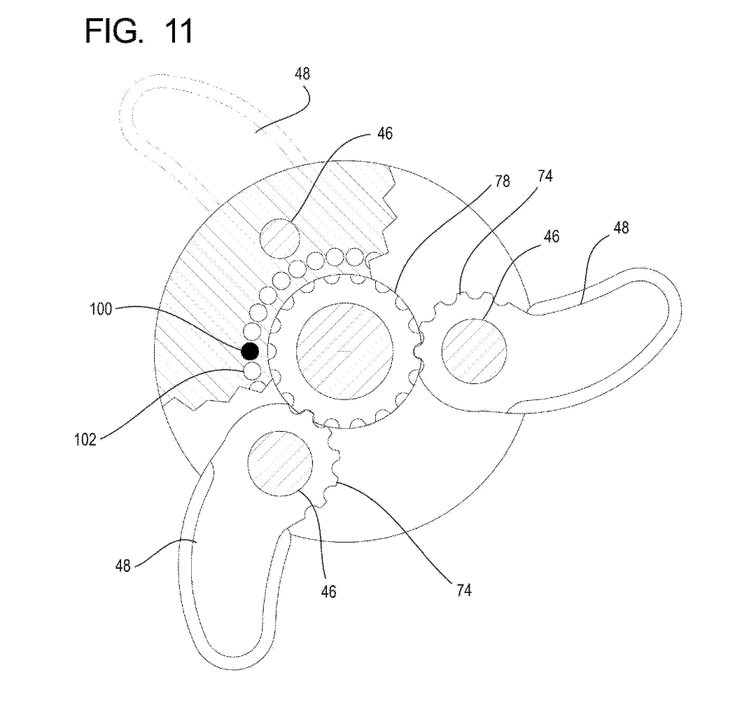

Looking to FIG. 4, it can be seen how as the main shaft gear 78 rotates relative to the pivot shafts 46, the arm gears 74 contact and are rotated by the main shaft gear 78 between the first arm gear tooth 80 and the last arm gear tooth 76. This rotation is accomplished as can be seen relative to FIG. 10. As the main shaft 78 is pressed downward relative to the lower disk 84, the index housing 92 will bias downward such that the index pin 100 is no longer engaged by any of the index pin receivers 102, (See FIG. 9) then movement of the main shaft 78 and/or indexer housing 92 relative to the lower disk 84 will rotate each of the bearing race engagement arms 48 radially inward or outward depending on the relative rotation of the index housing 92. This is also shown in the partial cutaway view of FIG. 11 and FIG. 12. In FIG. 12, the relative angle of rotation 104 is indicated based upon the rotation of the index housing 92 relative to the lower disk 84 from one index pin receiver 102A to an adjacent index pin receiver 102B.

Looking back to FIG. 8, a circumferential groove 106 is shown on the shaft 78 with a retaining ring 108 (piston ring, snap ring, e-ring, self-locking retaining ring, and equivalents) disposed therein. The retaining ring 108 provides a surface upon which a coil spring 110 disposed within a spring chamber 112 of the upper disk 82 or attached component presses to bias the main shaft and connected components longitudinally upwards. The coil spring 110 being of the compression type, although the apparatus may be re-configured for use of a tension coil spring. The coil spring 110 in this example extending radially between the outer surface 88 of the main shaft 24 and a radially inner surface 114 of the spring chamber 112. Likewise, the compression coil spring 110 is longitudinally disposed between a lower edge 116 of the spring chamber 112 and in the retaining ring 108. This coil spring 110 biases the main shaft 24 upwards away from the lower disk 84 and simultaneously biases the index pin 100 into the selected index pin receiver 102. The compression spring maintains the arms 48 in the desired extended or withdrawn position during operation. In FIG. 9 the index housing is positioned downward, and the spring 110 is compressed between the retaining ring 108 and the lower edge 116. In this example, the retaining ring 108 slides within the spring chamber 112. In this position as with the position shown in FIG. 8, at least a portion of the main shaft gear 78 engages each of the arm gears 74.

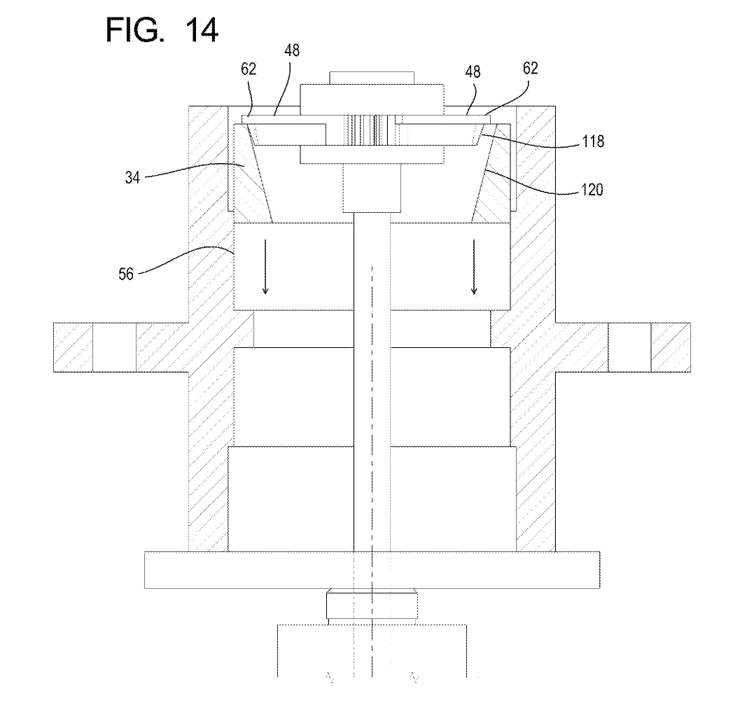

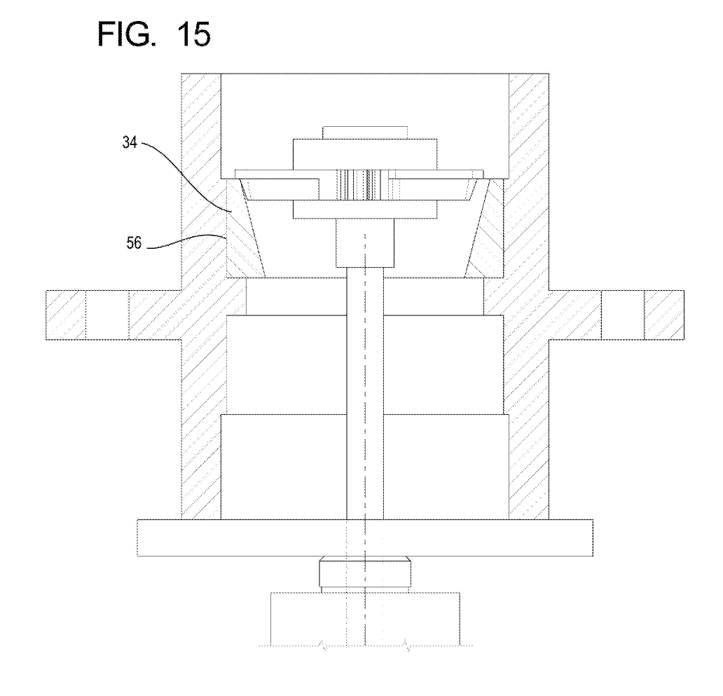

Looking to FIG. 13 is shown a variation of the arms 48 wherein the finger portion 62 is substantially the same, however, the arm portion 118 longitudinally above the finger portion 62 relative to the main shaft 24 is angled from a vertical plane. Looking to FIGS. 14 and 15, it can be seen how the entire apparatus is rotated or flipped vertically so as to be used to insert a bearing race 34 into the recess 56. In this particular example, the bearing race has an angular portion 120. In this example, the angular portion 118 of each arm 48 corresponds to the angular portion 120 of the bearing race 34 so as to more properly engage the bearing race during insertion whereas the arms shown in FIG. 1, for example, are substantially vertical and may interfere with insertion of a bearing race 34 such as shown in FIG. 14.

It is important to note that in FIGS. 14, 15 and also in FIG. 6, that although it appears in the drawings that the fingers 62 of one side of the apparatus do not contact the edge of the bearing race 34, this is an illusion caused by the example using three (3) arms in combination with the cutaway view.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

What is claimed is:

1. A gripping mechanism comprising:
a shaft defining a shaft axis;
an index housing defining a main gear and an indexing portion, where the index housing is supported by the shaft
a first support member;
a second support member defining at least one indexing surface;
at least one arm defining an arm gear and a finger portion;
a pivot member arranged to connect the at least one arm between the first and second support members such that
the first and second support members are supported for movement relative to the shaft along the shaft axis,
the at least one arm member pivots between first and second arm end positions relative to the first and second support members, and
the arm gear of the at least one arm member engages the main gear; whereby
the index housing may be arranged in
at least one locked position in which the indexing portion engages the at least one indexing surface to inhibit rotation of the index housing about the shaft axis, and
an unlocked position in which the indexing portion is disengaged from the at least one indexing surface to allow rotation of the index housing about the shaft axis; and
the main gear engages the arm gear such that
with the index housing in the unlocked position, rotation of the index housing about the shaft axis causes the at least one arm to pivot through at least one arm intermediate position between the first and second arm end positions, and
with the index housing in the at least one locked position, the at least one arm is held in the at least one intermediate arm position.

2. A gripping mechanism as recited in claim 1, further comprising:
a plurality of arms each defining an arm gear and a finger portion;
a plurality of pivot members, where each pivot member is arranged to connect one of the plurality of arms between the first and second support members such that
each of the plurality of arm members pivots between first and second arm end positions relative to the first and second support members, and
the arm gear of each of the plurality of arm members engages the main gear; whereby
the main gear engages the arm gears such that
with the index housing in the unlocked position, rotation of the index housing about the shaft axis causes each of the plurality of arms to pivot through at least one intermediate arm position between the first and second arm end positions, and
with the index housing in the locked position, the plurality of arms are held in one of the at least one intermediate arm position.

3. A gripping mechanism as recited in claim 1, in which:
a plurality of index openings are formed in the second plate, where each indexing surface defines one indexing surface;
the indexing portion is an indexing pin;
the indexing portion engages one of the plurality of indexing openings to lock the index housing in one of a plurality of locked positions; and
each locked position corresponds to one predetermined arm position between the first arm position and the second arm position.

4. A gripping mechanism as recited in claim 1, further comprising;
a base; and
pulling device supported by the base and operatively connected to the shaft; wherein
operation of the pulling device displaces the shaft along the shaft axis.

5. A gripping mechanism as recited in claim 1, further comprising a biasing system configured to bias the index housing into the locked position.

6. A gripping mechanism as recited in claim 5, in which the biasing system comprises a spring.

7. A gripping mechanism as recited in claim 5, in which the biasing system comprises:
a retainer supported by the shaft;
a spring supported between the retainer and the first support member; wherein
displacement of the shaft in a first direction relative to the first support member resiliently deforms the spring; and
the spring biases the shaft in a second direction relative to the first support member, where the second direction is opposite the first direction.

8. A gripping mechanism as recited in claim 7, further comprising a spring housing supported by the first support member such that the spring housing encloses at least a portion of the spring.

9. A gripping mechanism as recited in claim 1, in which:
the shaft defines a shaft threaded portion;
the index housing defines an index housing threaded portion; and
the index housing threaded portion receives the shaft threaded portion to detachably attach the index housing to the shaft.

10. A method of gripping a part comprising the steps of:
providing a shaft defining a shaft axis;
providing an index housing defining a main gear and an indexing portion;
supporting the index housing on the shaft
providing a first support member;
providing a second support member defining at least one indexing surface;
providing at least one arm defining an arm gear and a finger portion;
arranging a pivot member to connect the at least one arm between the first and second support members such that
the first and second support members are supported for movement relative to the shaft along the shaft axis,
the at least one arm member pivots between first and second arm end positions relative to the first and second support members, and
the arm gear of the at least one arm member engages the main gear; whereby
arranging the index housing in an unlocked position in which the indexing portion is disengaged from the at least one indexing surface to allow rotation of the index housing about the shaft axis;
rotating the index housing about the shaft axis to cause the at least one arm to pivot through at least one arm intermediate position between the first and second arm end positions; and
arranging the index housing in at least one locked position in which the indexing portion engages the at least one indexing surface to inhibit rotation of the index housing about the shaft axis, where the at least one arm gear is held in the at least one intermediate arm position when the index housing is in the at least one locked position.

11. A method as recited in claim 10, in which:
the step of providing at least one arm comprises the step of providing a plurality of arms each defining an arm gear and a finger portion;
the step of arranging at least one pivot member comprises the steps of arranging a plurality of pivot members such that each pivot member connects one of the plurality of arms between the first and second support members such that
each of the plurality of arm members pivots between first and second arm end positions relative to the first and second support members, and
the arm gear of each of the plurality of arm members engages the main gear; whereby
engaging the main gear with each of the arm gears such that
with the index housing in the unlocked position, rotation of the index housing about the shaft axis causes each of the plurality of arms to pivot through at least one intermediate arm position between the first and second arm end positions, and
with the index housing in the locked position, the plurality of arms are held in one of the at least one intermediate arm position.

12. A method as recited in claim 10, further comprising the steps of:
forming a plurality of index openings in the second plate, where each index opening defines one indexing surface;
forming an indexing pin on the second indexing housing;
engaging the indexing pin with one of the plurality of indexing openings to lock the index housing in one of a plurality of locked positions, where each locked position corresponds to one predetermined arm position between the first arm position and the second arm position.

13. A method as recited in claim 10, further comprising the steps of;
supporting a pulling device on a base;
operatively connecting the pulling device to the shaft; and
operating the pulling device to displace the shaft along the shaft axis.

14. A method as recited in claim 10, further comprising the step of biasing the index housing into the locked position.

15. A method as recited in claim 14, in which the step of biasing the indexing housing comprises the step of providing a spring.

16. A method as recited in claim 15, further comprising the steps of:
supporting a retainer on the shaft;
arranging a spring between the retainer and the first support member;
displacing the shaft in a first direction relative to the first support member resiliently to deform the spring; and
allowing the spring to force the shaft in a second direction relative to the first support member, where the second direction is opposite the first direction.

17. A method as recited in claim 16, further comprising the step of supporting a spring housing on the first support member such that the spring housing encloses at least a portion of the spring.

18. A method as recited in claim 10, in which:
the step of providing the shaft comprises the step of forming a shaft threaded portion on the shaft;
the step of providing the index housing comprises the step of forming an index housing threaded portion on the index housing; and
threading the index housing threaded portion with the shaft threaded portion to detachably attach the index housing to the shaft.

19. A gripping mechanism comprising:
a shaft defining a shaft axis;
an index housing defining a main gear and an indexing portion, where the index housing is supported by the shaft
a first support member;
a second support member defining a plurality of indexing surfaces;
a plurality of arms each defining an arm gear and a finger portion;
a plurality of pivot members, where each pivot member is arranged to connect one of the plurality of arms between the first and second support members such that
the first and second support members are supported for movement relative to the shaft along the shaft axis,
each arm member pivots between first and second arm end positions relative to the first and second support members, and
each the arm gear of the plurality of arm members engages the main gear; whereby
the index housing may be arranged in
a plurality of locked positions in which the indexing portion engages one of the plurality of index surfaces to inhibit rotation of the index housing about the shaft axis, and
an unlocked position in which the indexing portion is disengaged from the at least one indexing surface to allow rotation of the index housing about the shaft axis; and
the main gear engages the arm gear such that
with the index housing in the unlocked position, rotation of the index housing about the shaft axis causes the plurality of arms to pivot through a plurality of arm intermediate positions between the first and second arm end positions, and
with the index housing in one of the plurality of locked positions, the at least one arm is held in one of the plurality of intermediate arm positions.

20. A gripping mechanism as recited in claim 19, further comprising a biasing system comprising:
a retainer supported by the shaft;
a spring supported between the retainer and the first support member; wherein
displacement of the shaft in a first direction relative to the first support member resiliently deforms the spring; and
the spring biases the shaft in a second direction relative to the first support member, where the second direction is opposite the first direction.
